(19) United States
(12) Patent Application Publication
(10) Pub. No.: US 2014/0129365 A1
(43) Pub. Date: May 8, 2014

(54) SYSTEMS AND METHODS FOR NEGOTIATING A PURCHASE PRICE

(71) Applicants: Shawn Harris, Norton, MA (US); Joe Shartzer, Newmarket, NH (US); Tak-Sang Chan, Sharon, MA (US)

(72) Inventors: Shawn Harris, Norton, MA (US); Joe Shartzer, Newmarket, NH (US); Tak-Sang Chan, Sharon, MA (US)

(21) Appl. No.: 13/835,907

(22) Filed: Mar. 15, 2013

Related U.S. Application Data
(60) Provisional application No. 61/722,641, filed on Nov. 5, 2012.

(51) Int. Cl. G06Q 30/08

(52) U.S. Cl. CPC G06Q 30/08
USPC 705/26.3

(57) ABSTRACT

Systems and methods to facilitate a purchase of a product by a user from a seller.

### CROSS REFERENCE TO RELATED APPLICATIONS

The present application claims priority to U.S. Provisional Application No. 61/722,641, filed Nov. 5, 2012, and entitled “SYSTEMS AND METHODS FOR NEGOTIATING A PURCHASE PRICE,” which application is incorporated herein by reference in its entirety.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### FIELD OF THE DISCLOSURE

The present application relates generally to the field of electronic commerce (e-commerce). More specifically the present application relates to systems and methods to facilitate purchase price negotiations in e-commerce environments.

### BACKGROUND OF THE DISCLOSURE

Many retail markets implement flat-pricing models in brick and mortar store settings. As brick and mortar retailers transition to selling more goods through e-commerce resources and as new retailers enter the market through pure e-commerce models, both generally continue to operate on flat pricing models, offering products to the general public at a price that is generally the same for each customer.

### SUMMARY

The inventors have appreciated that current e-commerce sale models fail to capture profits from buyers that are willing to pay a premium for a product while simultaneously capturing buyers willing to purchase the same product at a lower premium, but at a price point that is still profitable to the seller. Inventive embodiments disclosed herein provide e-commerce sale models that gauge each buyer's willingness to purchase in a non-competitive marketplace that allows a retailer to obtain sales and profits in mass that might otherwise be lost through flat pricing models and allows a buyer to purchase at prices that suit the buyer's personal preference. In view of the foregoing, the present disclosure is directed to systems and methods for facilitating negotiated purchase prices.

Various exemplary embodiments provide a method of facilitating a purchase of a product by a user. Such embodiments, provide a method that includes causing, by a server, on a display device, a display of a product available for purchase and a price for the product available for purchase. The server provides a user interface to the display device for the user to submit a purchase offer for purchase of the product at or below the price. The server also provides an incentive to the user. The incentive is conditioned on the server accepting the purchase offer for the product. The method includes receiving, by the server, via the user interface, the purchase offer for purchase of the product at or below the price from the user. The method includes determining, by the server, to accept the purchase offer if the purchase offer has a value greater than a threshold value. The threshold value comprises a baseline cost of the product and a quantification of the incentive. The method includes providing, by the server, responsive to the determination to accept the purchase offer, the incentive to the user.

In various exemplary embodiments, the method includes determining, by the server, to reject the purchase offer, if the purchase offer has a value less than or equal to the threshold value. The method may further include providing, by the server, responsive to the determination to reject the purchase offer, a counter offer to the user. The counter-offer may include a counter-offer incentive. The counter-offer incentive is conditioned on the user accepting the counter-offer. In various embodiments, the counter-offer incentive is determined based on a difference between the purchase offer and the threshold value. At least one of the counter offer and the counter offer incentive may be determined based on an offer state, wherein the offer state quantifies the number of offers the user has made for the product, in accordance with various embodiments. The value of the counter-offer incentive may be less than the incentive.

In various embodiments, the threshold value further comprises a minimum profit value.

The incentive may include a currency.

The incentive may include a credit towards a subsequent purchase.

The incentive may include a second product.

In various embodiments, the second product is chosen based on a behavior of the user.

The purchase offer may include a credit from a prior purchase in accordance with various embodiments.

The product available for purchase may be from a single seller.

The baseline cost of the product may below the price of the product.

The price of the product may be a manufacturer suggested retail price.

In accordance with various embodiments, the method includes causing, by the server, on the display device, a display of a written description of the product.

Various exemplary embodiments provide a system for facilitating a purchase of a product by a user from a seller. The system includes a product purchase engine, the product purchase engine is configured to cause a display of product data corresponding to a product available for purchase; cause a display of a price for the product available for purchase; provide a user interface for the user to submit a purchase offer for purchase of the product at or below the price; provide an incentive to the user, the incentive conditioned on the product purchase engine accepting the purchase offer for the product; receive, via the user interface, the purchase offer for purchase of the product at or below the price from the user; determine, to accept the purchase offer if the purchase offer has a value greater than a threshold value, the threshold value comprising a baseline cost of the product and a quantification of the incentive; and provide, responsive to the determination to accept the purchase offer, the incentive to the user.

In various embodiments, the product purchase engine is further configured to reject the purchase offer, if the purchase offer has a value less than or equal to the threshold value and provide, responsive to the rejection of the purchase offer, a counter offer to the user.

The product data includes an image representative of the product available for purchase, in accordance with various exemplary embodiments.

Various exemplary embodiments provide a system for facilitating a purchase of a product by a user. The system includes a server configured to cause, on a display device, a display of a product available for purchase and a price for the product available for purchase. The server is configured to provide a user interface to the display device for the user to submit a purchase offer for purchase of the product at or below the price. The server is also configured to provide an incentive to the user. The incentive is conditioned on the server accepting the purchase offer for the product. The server is further configured to receive, via the user interface, the purchase offer for purchase of the product at or below the price from the user. The server is further configured to determine, to accept the purchase offer if the purchase offer has a value greater than a threshold value. The threshold value comprises a baseline cost of the product and a quantification of the incentive. The server is further configured to provide, responsive to the determination to accept the purchase offer, the incentive to the user.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client devices in communication with server devices;

FIG. 1B is a block diagram depicting a cloud computing environment comprising client devices in communication with a cloud service provider;

FIGS. 1C and 1D are block diagrams depicting embodiments of computing devices useful in connection with the methods and systems described herein.

FIG. 2 is flow diagram illustrating operations of a negotiable pricing system in accordance with exemplary inventive embodiments.

FIG. 3 is a flow diagram illustrating operations of another negotiable pricing system in accordance with exemplary inventive embodiments.

FIG. 4 is a flow diagram illustrating operations of yet another negotiable pricing system in accordance with exemplary inventive embodiments.

FIG. 5 is a screen shot of a negotiable pricing system in the process of obtaining an initial offer from a member in accordance with exemplary inventive embodiments.

FIG. 6 is a screen shot of a payment entry process for a negotiable pricing system in accordance with exemplary inventive embodiments.

FIG. 7 is a screen shot of a negotiable pricing system countering an offer of a member in accordance with exemplary inventive embodiments.

FIG. 8 is a flow diagram illustrating a registration and negotiation process in accordance with exemplary inventive embodiments.

The features and advantages of the incentive embodiments disclosed herein will become more apparent from the detailed description set forth below when taken in conjunction with the drawings.

### DETAILED DESCRIPTION

Following below are more detailed descriptions of various concepts related to, and embodiments of, inventive systems and methods for negotiating a purchase price of a selected product between a buyer and a seller. For purposes of reading the description of the various embodiments below, the following descriptions of the sections of the specification and their respective contents may be helpful:

Section A describes a network environment and computing environment which may be useful for practicing embodiments described herein.

Section B describes embodiments of systems and methods facilitating negotiations between a buyer and seller over the purchase price for a selected product.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

A. Computing and Network Environment

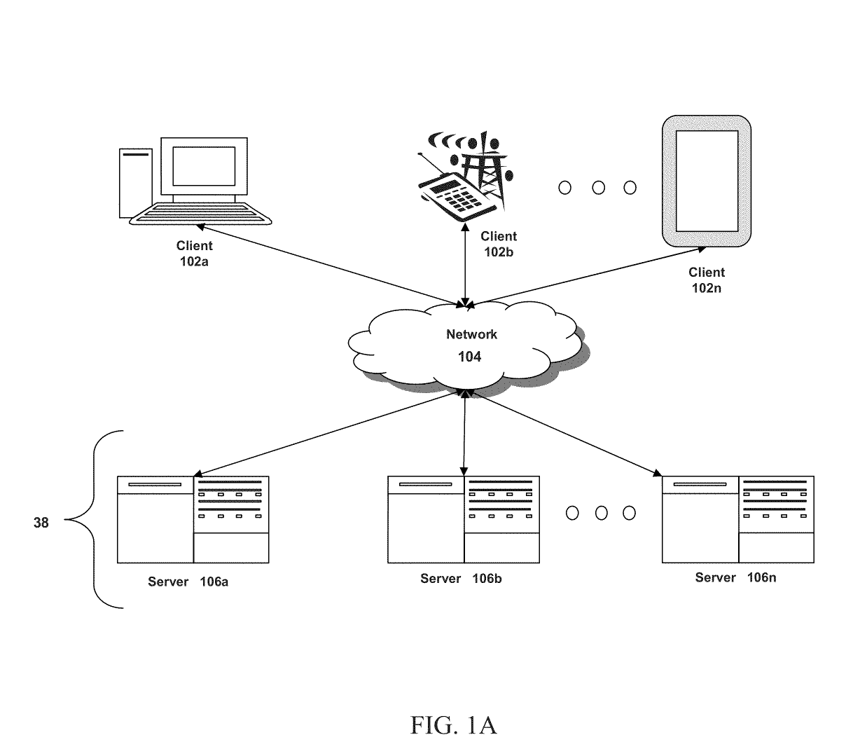

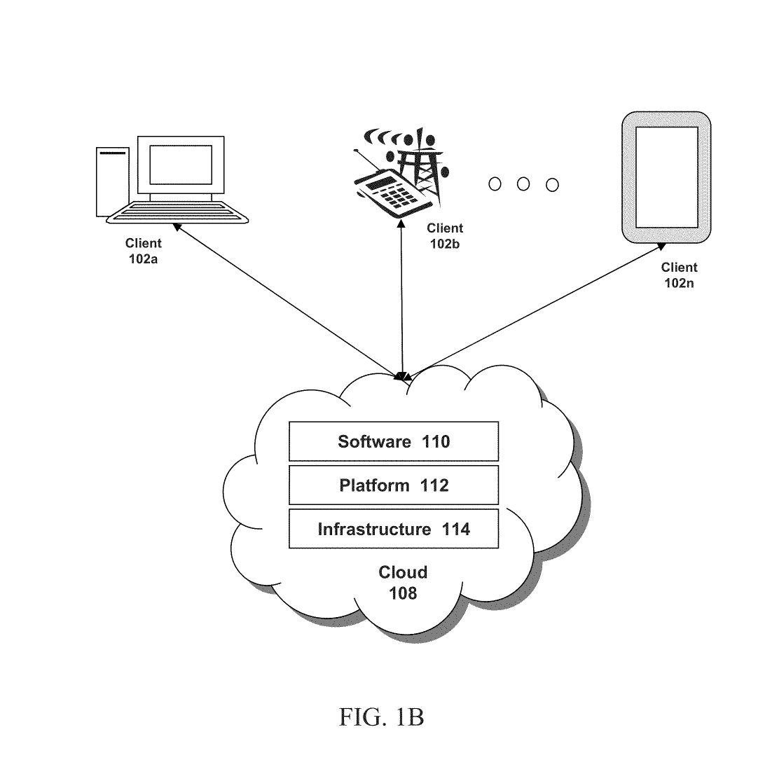

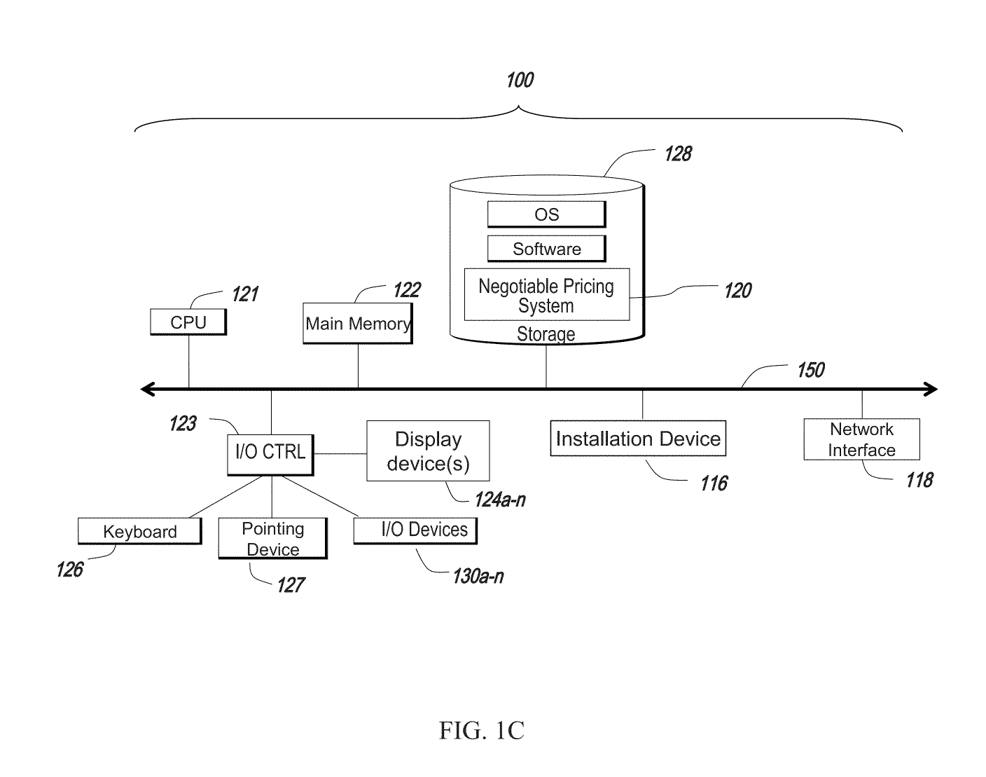

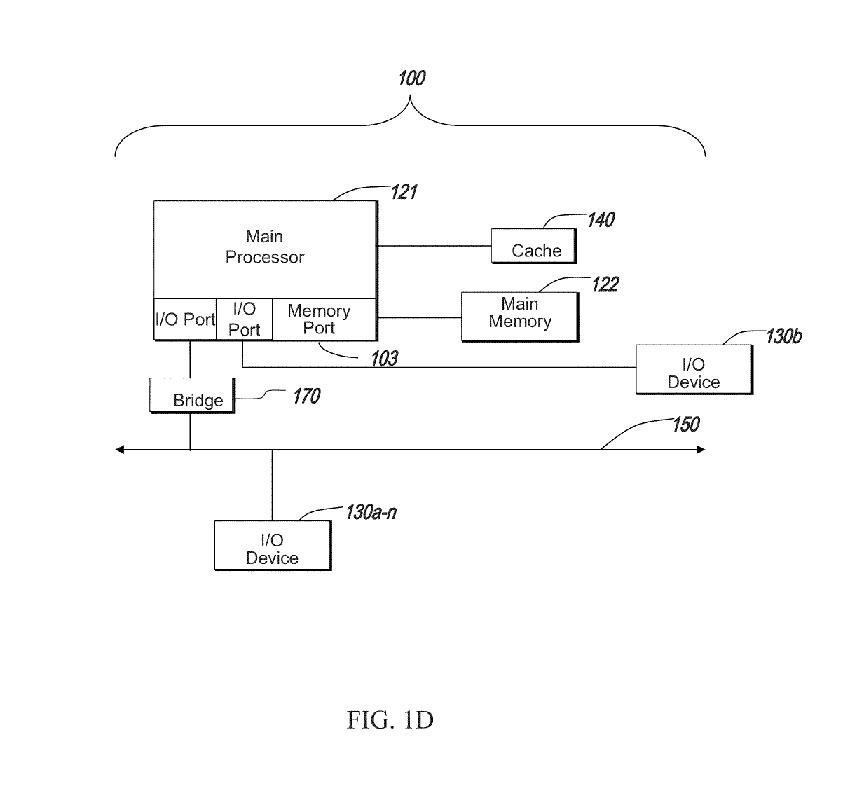

Prior to discussing specific inventive embodiments, it may be helpful to describe aspects of the operating environment as well as associated system components (e.g., hardware elements) in connection with the methods and systems described herein. Referring to FIG. 1A, an embodiment of a network environment is depicted. In brief overview, the illustrated exploring network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network, which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualized physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, and/or software of a negotiable pricing system 120. As shown in FIG. 1D, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1D depicts an embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120 for the negotiable pricing system. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via an I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is an eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the negotiable pricing systems and methods disclosed herein.

B. Negotiable Pricing System

A negotiable pricing system, may be implemented to engage in a product purchase by a single buyer from a single seller. In some embodiments, the seller may through a client device, such as client devices 106, engage a retailer operating a negotiable pricing system or a purchase engine configured to facilitate a negotiated purchase price of a product available for purchase, for example, on a server device 106 or in the cloud 108. The negotiable pricing system may be implemented through negotiable pricing system software, such as software 110, operating on a device such as server 106 through a network or through the cloud, such as cloud 108. The negotiable pricing system or engine may include a plurality of modules and interactive subcomponents engaged for operating the negotiable pricing system. The negotiable pricing system and any components or modules thereof may comprise an application, a program, a library, a script, a service, a process, a task, or any type and form of executable instructions executed on a device. For example, the system or purchase engine may include an optimization engine and/or rule selection module for parsing through and analyzing uploaded or updated data and for selecting the one or more appropriate business rules or algorithms required to respond to the uploaded data at various points in a negotiation process, an authentication module for verifying the accuracy of information and or the source of the information, a visualization module for producing various displays or user interfaces as appropriate on a display device or graphical user interface, a comparator module for analyzing values, a determinant module for analyzing values and/or rules, an error detection module, a counter or bit generation module, as well as other modules or components for implementation of various embodiments of the negotiable pricing system disclosed and described herein.

The negotiable pricing system and any components or modules thereof may comprise an application a program a library a script a service a process a task or any type and form of executable instructions executed on a device.

Various negotiable pricing system embodiments may be activated through a website hosted on the internet by or on behalf of a retailer, through which website remote users may engage in one on one direct buyer to seller negotiations with the retailer to purchase a user specified and selected item from the retailer at a price that the specific user buyer is willing to pay and at a price the retailer seller is willing to sell. In various embodiments, the negotiable pricing system may be operated by the retailer. In various embodiments, the negotiable pricing system may facilitate a purchase from one or more third party retailers to a purchaser. In some embodiments, the system may be implemented with user buyers that are registered members. Embodiments of the negotiable price system permit making offers, by the buyer and seller, offering variable rewards as part of the negotiation, which rewards may be monetary, products, points, service, etc., and fixing or varying the number of offer attempts. As discussed further herein, a member's offer amount and offer state impacts the members rewards. Various embodiments of the negotiable pricing system implement algorithms to determine whether an offer is acceptable or should be rejected and to determine any appropriate counter offers, factoring in various elements such as rewards, offer prices, retail price and other elements as discussed further herein.

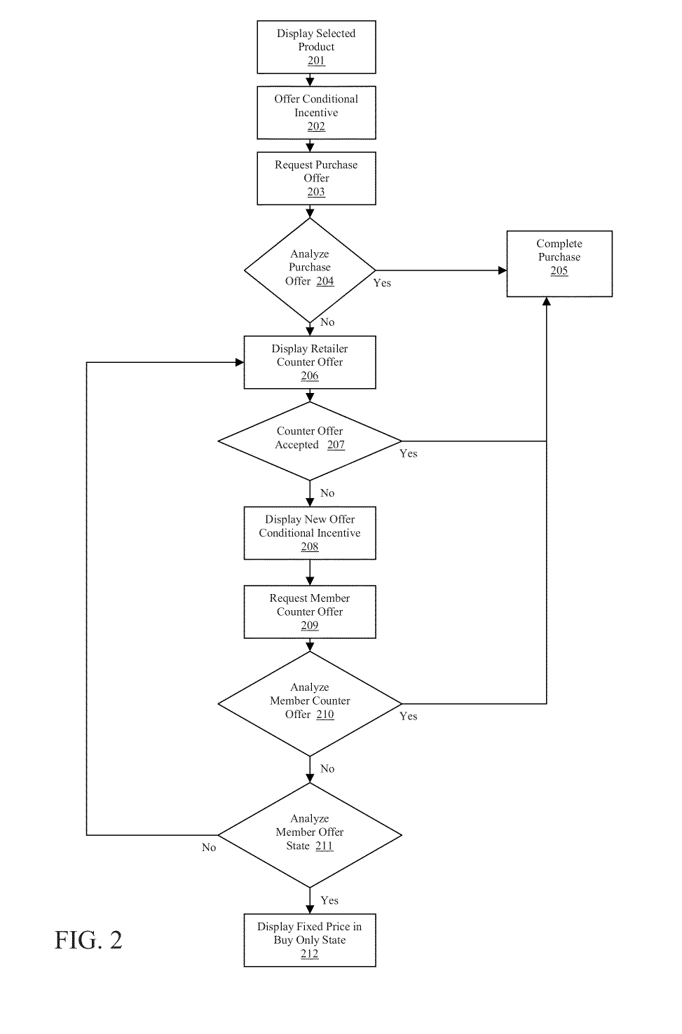

FIG. 2 is flow diagram illustrating operations of a negotiable pricing system in accordance with exemplary inventive embodiments to facilitate a negotiated price for the purchase of a product. In operation 201, the negotiable pricing system displays data corresponding to a product available for purchase by a user, such as an image of the product and/or a description of the product and a price. The data display may be initiated by the server and/or a visualization module. The display may be generated through a user interface and may be depicted on a display device such as a graphical user interface, for example on a client device, such as a laptop, hosted computer, tablet, PC, mobile phone, or other electronic device. The product displayed, which corresponds to the actual item the member or user and the retailer will negotiate a price for, may be depicted by multiple views or perspectives of the product and additional descriptive information about the product such as a manufacturer suggested retail price (MSRP) or a list price and a brief or detailed description of the item. In operation 202, the system causes a display of an incentive, conditioned on an acceptance of a purchase offer, or reward to a member. In accordance with various embodiments, the incentive may be currency, an object, such as a product, a credit towards a subsequent purchase, etc. In accordance with various embodiments, an incentive such as a product may be selected based on a user or purchaser behavior, such as other items or products viewed by the user, items related to the product for which a price is being negotiated. The offer conditional incentive may provide a specific incentive such as a currency for use within the system, a rebate, or a specific discount on an item, which incentive will be available to the member if a first purchase offer made by the member is accepted. In operation 203, the system may request through the user interface that the member submit his or her initial purchase offer. The request of operation 203 may be facilitated through the display of a data field or data entry box with an appropriate corresponding label, such as “My Offer,” “First Offer,” “Starting Offer,” etc. in the user interface. In accordance with some embodiments, the processes represented by multiple operations such as operations 201-203 may be achieved through a single display, single screen, or user interface. For example, as will be demonstrated further herein a single display may depict the product selected for purchase, the offer conditional incentive, and the data entry box for receipt of the member's initial offer. In accordance with various embodiments, each operation may be facilitated by a distinct or separate display.

Once a member submits an offer in operation 203 and the negotiable pricing system or purchase engine receives the purchase offer, the negotiable pricing system will perform an analysis on the offer in step 204 to determine to accept or reject the offer. The analysis implemented in step 204, which may be implemented by one or more components of the negotiable pricing system, such as a comparator module or determinant module, may compare the offer submitted by the member with a calculated threshold price representative of a minimum price at which the retailer is willing to sell the displayed product. The threshold value may include a quantification of the incentive, a baseline cost of the product and a profit value or profit value range, which may be a percentage of the baseline price. The baseline cost may include the price the retailer purchases the product for, a wholesale price, an invoice price, etc. The calculated threshold price remains unknown to the member and may be determined by an algorithm weighing the baseline cost of the product selected to the retailer and the offer based incentive. The analysis of operation 204 will determine whether to accept the member offer or reject the member offer. The analysis of operation 204 will also determine whether to make a counter-offer if the members offer is rejected and if making a counter-offer the operation will calculate the price of the counter offer through suitable algorithms and may also include calculations the value of a subsequent incentive or counter-offer incentive. This determination may include calculating the spread between the initial member offer, and the calculated threshold price and making a counter offer in operation 206 based on the spread. If the offer is accepted, the member may be directed to a purchase completing process represented by operation 205. In some embodiments, the negotiable pricing system may accept any offer exceeding the calculated threshold price. In some embodiments, the negotiable pricing system may accept any offer exceeding the calculated threshold price by a predetermined amount. In some embodiments, the negotiable pricing system may make a counter offer for any member offer that is below the MSRP by a predetermined amount, which amount may be based on the offer based incentive. For a member offer that is below the calculated threshold the negotiable pricing system may make a counter-offer, in accordance with various embodiments, based on the spread below the calculated threshold while other embodiments may simply request a new offer by the member. In embodiments, such as depicted in FIG. 2, where a counter offer is calculated and displayed in operation 206, the negotiable pricing system may proceed to operation 207 to analyze acceptance or rejection of the counter offer. If the counter offer is accepted, the member may be directed to the purchase completion process represented by operation 205. If the counter offer is rejected, the negotiable pricing system may request that the member provide his or her own counter offer in operation 209. The request for a member counter offer in operation 209 may be prefaced in some embodiments by presentation of a new offer conditional incentive or counter offer incentive (conditional on acceptance by the system of the counter offer that the member presents), which incentive may have a value below the original incentive value. In various embodiments, the incentive may have a value equal to a percentage of the price of MSRP and a counter-offer incentive may have a value of a lower-percentage of the price with respect to the earlier percentage. Once the member submits a counter-offer in operation 209, the negotiable pricing system analyzing the offer in operation 210 determines whether to accept or reject the member counter offer. If the member counter offer is accepted, the member may be directed to the purchase completing process by operation 205. If the member counter offer is rejected, the state of the counter offer may be analyzed in operation 211 to determine whether or not the user has reached a predetermined number of offers, for example three member offers (including initial offers and counter offers). While embodiments demonstrate three available offers, the number of allowed offers may vary in accordance various embodiments. For example, in some embodiments a member may be allowed to submit only two offers, while in other embodiments a member may be limited to four offers. If the analysis in operation 211 determines that the member has not reached the predetermined number of offers, the member may be redirected to operation 206 where a new counter offer will be calculated and displayed based on the spread between the member offer (in this instance represented by the member counter offer) and the calculated threshold price. If the analysis in operation 211 determines that the member has reached the predetermined number of offers and the offer was not accepted per operation 210, the member will be directed to a display which prevents the member from submitting a new counter offer and only allows the user to buy the product at a fixed price. The fixed price may be less than the MSRP, in accordance with some embodiments. Prevention of the user from submitting a new offer may be instituted for a predetermined period of time, for example 48 hrs.

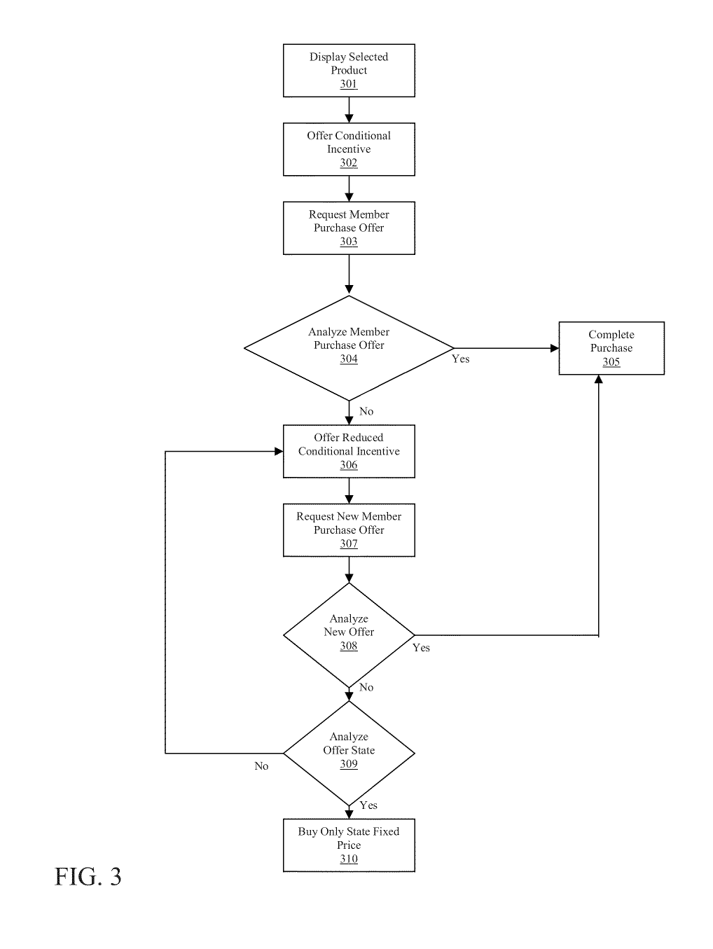

FIG. 3 is a flow diagram illustrating operations of another negotiable pricing system, in accordance with exemplary inventive embodiments. Unlike the negotiable pricing system in FIG. 2, the system or engine in FIG. 3 may be configured to provide a user interface allowing a buyer to make all of the offers, to set the specific value of the offers, without requesting or presenting a counter-offer from the retailer. In the embodiment depicted in FIG. 3, although the retailer may not make counter offers, varying offer conditional incentives may be presented if a member is purchase offer is not accepted. More specifically, in operation 301 the system displays an item selected by the member for purchase from the retailer in a manner similar to the display operation 201 provided in connection with FIG. 2. The product displayed may include various views of the product and may also include additional information about the product, such as the MSRP and/or a written description of the item. In operation 302, the system may display an offer conditional incentive or an incentive conditioned on acceptance of a purchase price to a member. The offer conditional incentive may provide a specific incentive such as currency for use within the system, a rebate, or a specific discount on the item of negotiation, a separate product, a gift certificate, etc., which may be based on user behavior for example within the negotiable pricing system. if a first offer made by the user is accepted. If for, for example, the offer conditional incentive is currency, the incentive may be used by the member for the transaction under negotiation if the offer is accepted or the incentive may be used by the member for purchase of a different item in a distinct or subsequent transaction through the negotiable price system if the offer in the current transaction is accepted. In operation 303, the system provides a prompt or data entry field which allows the member to specify a purchase offer. In operation 304, the purchase offer is analyzed to determine what, if any, spread exists between the purchase offer and a calculated retailer threshold price. If the spread is less than a predetermined quantity, the system may accept the offer on behalf of the retailer and direct the member to the purchase completion process in operation 305. If the spread is greater than a predetermined quantity, the system may proceed to display a reduced offer conditional incentive in operation 306 and request a new offer from the member. The amount of the reduction in the offer conditional incentive may indicate to the user the level disparity between the offer and the desired purchase price of the retailer, thereby impacting and incentivizing any subsequent offers by the member in an effort to limit further reductions in the incentive and thereby assisting in bridging the gap between the members willingness to purchase and the retailers willingness to sell. In operation 307, the system provides a prompt or entry field, which allows the member to make a subsequent purchase offer. In operation 308, the subsequent purchase offer is analyzed, to determine what, if any spread exists between the purchase offer and the calculated retailer threshold price, which threshold price factors in the present offer conditional incentive offered to the member. If the spread is less than a predetermined quantity, the system may accept the offer on behalf of the retailer and direct the member to the purchase completion process in operation 305. If the spread is greater than a predetermined quantity, the system may reject the subsequent purchase offer and proceed to analyze the state of the offer in operation 309. If the subsequent member purchase offer is rejected, the state of the counter offer may be analyzed in operation 309 to determine whether or not the member has reached a predetermined number of offers, for example three member offers (including initial offers and counter offers). If the analysis in operation 309 determines that the member has not reached the predetermined number of offers, the member will be redirected to operation 306 displaying a further reduced offer conditional incentive and subsequently operation 307 allowing the member to make another subsequent purchase offer. If the analysis in operation 309 determines that the member has reached the predetermined number of offers and the offer was not accepted per operation 308, the member will be directed, by operation 310, to a display which prevents the user from submitting a new counter offer and only allows the user to buy the product at a fixed price.

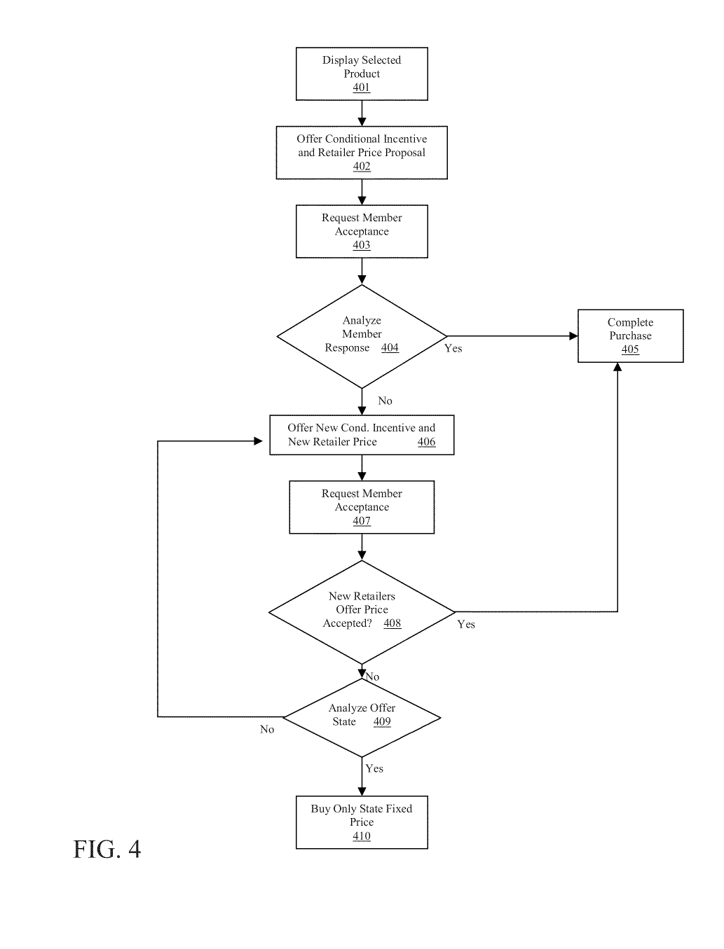

FIG. 4 is a flow diagram illustrating operations of yet another negotiable pricing system, in accordance with exemplary inventive embodiments. Unlike the system in FIG. 2 and FIG. 3, the system in FIG. 4 may be configured to allow the retailer to make all of the offers, to set the specific value of the offers, without requesting counter offers from the member. Accordingly, the member may only be permitted in such an embodiment to accept or reject offers made by the retailer. More specifically, in operation 401 the system displays an item selected by the member for purchase from the retailer in a manner similar to the display operation 201 provided in connection with FIG. 2 and the display operation 301 provided in connection with FIG. 3. The item displayed may include various views of the item and may also include additional information about the item such as the MSRP or a written description of the item. In operation 402, the system may display an offer conditional incentive to a member and a proposed retailer sale price. The offer conditional incentive may provide a specific incentive such as currency for use within the system, a rebate, or a specific discount on the item of negotiation if a first offer made by the user is accepted. If, for example, the offer conditional incentive is currency, the offer conditional incentive may be used by the member for the transaction under negotiation if the offer is accepted, or the offer conditional incentive may be used by the member for the purchase of a different item in a distinct transaction if the offer in the current transaction is accepted.

In operation 403, the system provides a prompt through the user interface for the member to accept the proposed retailer sale price. The system analyzes the member's response in operation 404 and makes a decision or determination based thereon. If the member has accepted the retailer purchase offer, the system directs the member to the purchase completion process, operation 405. If the member has rejected the retailer purchase offer, the system, in operation 406, displays a new retailer purchase and a new offer conditional incentive for the user. The system prompts the member to accept the new proposed retailer sale price in operation 407, for example by prompting the member to click, for example click an icon in the user interface, if the proposed retailer sale price is acceptable or by asking the user to accept.

In accordance with various inventive embodiments, aspects of the negotiation process may be enhanced by various user engagement activities. For example, in addition to prompting the user to accept and offer, reject an offer, make a counter offer, etc. by allowing the user to click on a selection or enter an amount in a field, such selections may be made be user perceptible gestures or activities such as voice recognition or motion recognition. For example, a user may be able to speak or shout a phrase such as “I accept” or “sold” to accept a counter offer. A user may be able to speak a proposed counter offer and a counter offer made by the retailer may be communicated through an audio component such as a computer speaker or a speaker of a mobile electronic device. For example, an electronic device may communicate through an audio component “I will sell you this perfume at $55.00 and give you $5.00 dollars in reward money. Will you accept my offer?” In some embodiments, a user may be able to reject an offer through motions in a device equipped with sensors such as accelerometers, for example by shaking a mobile device, such as a mobile phone, from side to side.

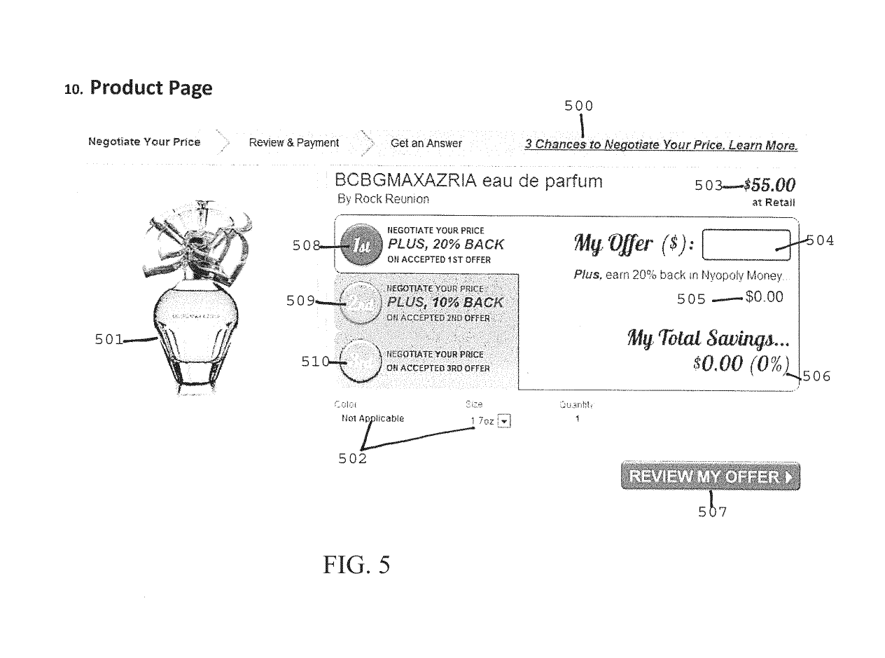

FIG. 5 is a screen shot of an embodiment of a negotiable pricing system in the process of obtaining an initial offer from a member. As demonstrated in the illustrated embodiment, the negotiable pricing system may provide a product negotiation view 500 that shows a member selected product image 501, provides a product description 502, and shows a retail price 503, such as a MSRP. View 500 may also include a request for a member to provide an offer through the fillable “My Offer” data entry field 504. View 500 further shows an exemplary offer conditional incentive 505, here characterized as “Nyopoly Money.” Once a member enters a value in the “My Offer” field the “Nyopoly Money & Total Savings” may be automatically calculated without further action by the member. As discussed above and as further demonstrated in view 500, the Nyopoly Money is an incentive that is conditioned on acceptance and the state of the offer. As noted by offer state 508 representative of a 1^{st} offer, the offer conditional incentive allows the member to receive 20 percent of their offer price back in the Nyopoly Money currency if the member's first offer is accepted. In some embodiments, the Nyopoly Money currency or other offer conditional incentive may only be used in subsequent purchases. View 500 further illustrates how the value of the incentive may be described in cash equivalent 506. The cash value equivalent of the incentive may be updated in response to the user entering an offer amount in data entry field 504. Once the user is satisfied with a first offer, the member may select “REVIEW MY OFFER” via icon 507 to proceed toward submission of the offer to the negotiable pricing system for a determination of acceptance or rejection. As demonstrated by offer state 509, if the first offer is not accepted and a user enters a subsequent offer, the offer may have a reduced offer conditional incentive 505, for example 10 percent. In some embodiments, if the user's first two offers are not accepted and the user is making a third or final, in some embodiments, offer 510 the final offer 510 may forgo any offer conditional incentive. In some embodiments, the reduction in the offer conditional incentive may be predetermined and revealed to the user prior to submission of the initial offer. The pre-knowledge of the prospective incentive reduction may prompt the user to submit a higher offer to limit the prospective offer conditional incentive reduction.

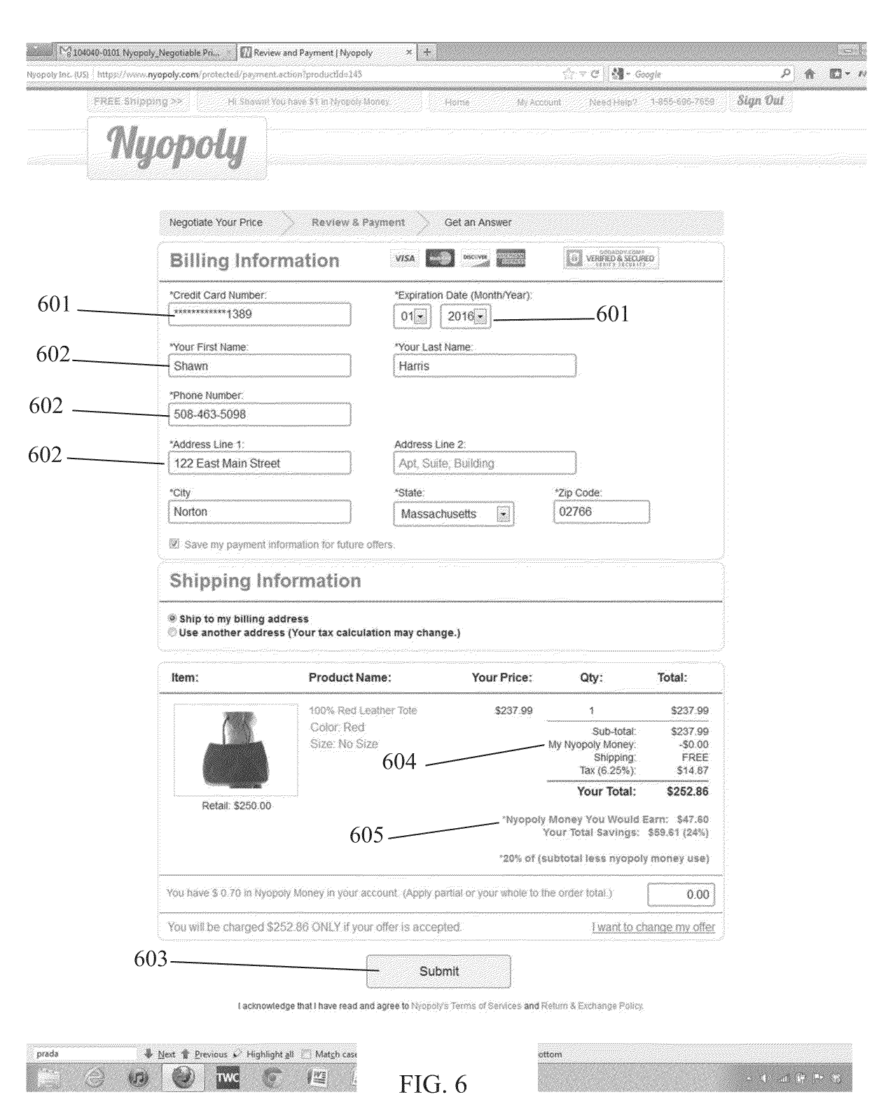

In accordance with various embodiments, the user may be required to provide payment information before making a final submission of the member's offer. The payment information may be a pre-requisite that commits the user to pay the submitted offer price if the offer is accepted. In accordance with various embodiments, selecting “REVIEW MY OFFER,” may move the member to a payment entry form as demonstrated by the screen shot illustrated in FIG. 6. The payment entry process may occur before final submission and analysis of the initial offer, in accordance with various inventive embodiments. In various embodiments, the payment entry process may occur after an offered product purchase has been accepted or similarly after a counter-offer has been accepted by the user. The payment entry process may require the user to enter payment information in data entry field 601, such as credit card payment information and may also require the user to confirm the bibliographic information in data entry fields 602 in connection with the payment information. Once the member has entered the appropriate payment information, the member may proceed to select the submission icon 603 to have the offer provided in field 504 of FIG. 5 considered by the negotiable pricing system. Prior to submission the member may review the financial implications of their offer and other factors impacting the same such as the quantity of rewards or incentives previously received 604 and currently credited towards the present transaction and the offer conditional incentive 605 that will be earned if the members offer is accepted. Upon submission of the offer and payment information, the negotiable pricing system may initiate an algorithm to determine whether the retailer is willing to accept the offer based on numerous factors, which may include the retail price of the product, the offer conditional incentive, the member offer amount, and/or the state of the offer. In some embodiments, the algorithm may determine whether the retailer is willing to accept the offer based on additional factors related to the member, such as the member's purchasing history, if any, including prior spreads between offer and retail prices, number of offers, number of purchases, etc. The algorithm may factor in other information in some embodiments, such as demographics about the member's age or gender, geographical information, occupation, credit history, salary, or other member information identified based on the member registration information, payment information, or other linked sources. In some embodiments, the algorithm may factor in the sale success of the product via the negotiable pricing system, as determined through other online shopping sites, and/or historical sales data of brick and mortar stores. In some embodiments, the algorithm may factor in total purchase requests made on the site for the item, for example to gauge and factor in the community demand for the product, the retailer's current inventor for the product, and/or seasonal factors such as proximity to holiday shopping seasons. Once the algorithm has factored in all of the known and/or relevant factors implemented in a given embodiment, the algorithm will either accept or reject the offer. If the offer is rejected, the negotiable pricing system may present a counter offer.

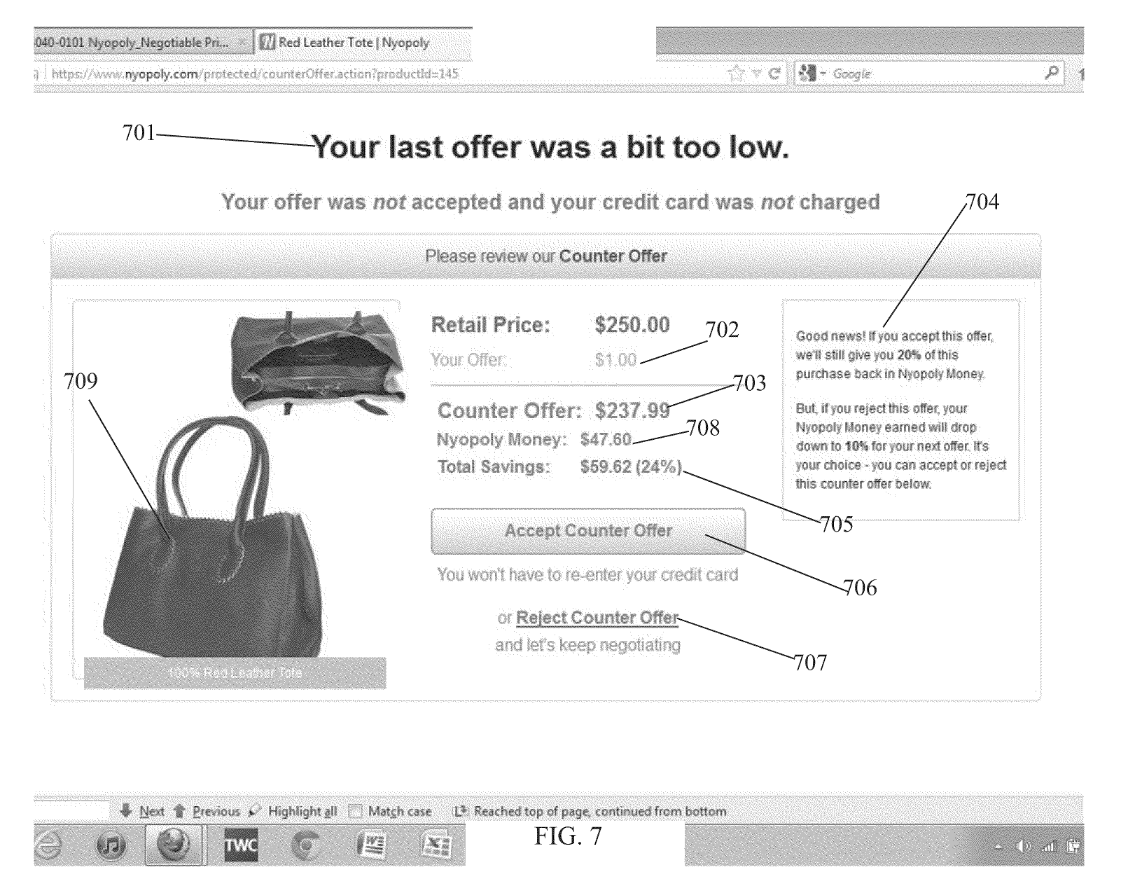

FIG. 7 is a screen shot of a negotiable pricing system countering an offer of a member in accordance with exemplary inventive embodiments. If the negotiable pricing system rejects a member offer, the system may cause a view such as the view shown in FIG. 7 to display the member's device. The rejection of the member offer may be communicated by a message such as message 701. The negotiable pricing system may have a plurality of messages, which may be used to communicate to a member that the member's offer has not been accepted. The choice of the message may depend on the spread between the offer and the calculated threshold price with a sliding scale for the message choice depending on the corresponding level of the offer. For example for offers that are greater than the calculated threshold by a larger margin, a message encouraging a slight increase may be used whereas for offers that are just barely above the calculated threshold or that are below the calculated threshold, a message may be provided that lets the member know that they are quite far off. As demonstrated by FIG. 7, as the negotiations continue, the selected product image 709 may continue to display. Other information such as the previous offer 702 made by the member may also be shown. A counter offer 703 may be made by the retailer. The quantity of the counter offer 703 may be calculated by an algorithm based on the spread between the offer and the calculated threshold. Other information such as the offer conditional incentive 704, the value of the offer conditional incentive 708, and the quantified total savings 705 associated with the offer may be illustrated on the display. The quantified total savings 705 may factor in the offer conditional incentive and the offer price even if the value of the offer conditional incentive 708, is used towards another purchase (e.g. a separate purchase made by the member occurring in connection with a distinct negotiation between the member and the retailer through the negotiating pricing system). The user may be prompted to accept the counter offer, for example by selecting icon 706, or to reject the counter offer, for example by selecting icon 707. If the user rejects the counter offer, the user may be taken back to a screen similar to that shown in FIG. 5 to continue negotiating through the submission of a new offer by the member and a new offer conditional incentive by the retailer. A single negotiation may span multiple log-in sessions in accordance with various embodiment. For example, a member may submit a first offer, have that offer rejected and be presented with a counter offer. The member may log out after receiving a counter offer and return the next day to submit a second offer.

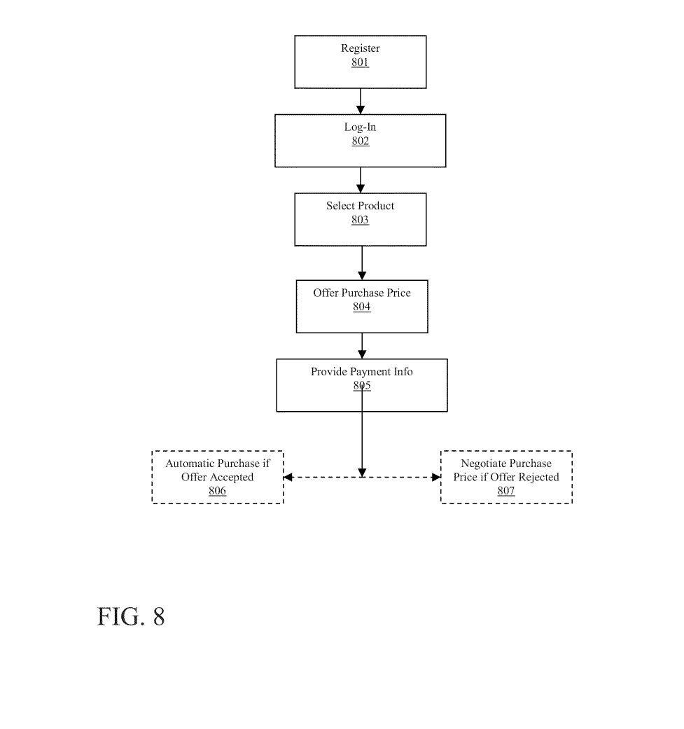

FIG. 8 is a flow diagram illustrating a registration and negotiation process in accordance with exemplary inventive embodiments. In accordance with various embodiments, upon arrival at a web page hosting the negotiating pricing system, a user may be prompted to register to begin using the site to search for items. The member's access to the website may be limited prior to registration such that the user can't purchase, but can obtain limited information such as some of the products that may be purchased at a discounted price through the website or details about the negotiation process. In some embodiments, testimonials may be available to an unregistered user. Once the user registers in step 801, the user will then be able to log-in to the site in step 802 to begin the personalized pricing shopping experience. In some embodiments, there may be varying levels of membership, which permit varying levels of product access, discounts, and deals. Once logged in a member may proceed to browse available products and may select, in step 803, a specific product to negotiate or haggle over the product. Once an offer is provided in step 804 the user may proceed to provide payment information in step 805 to make the offer firm. If the offer is accepted, the payment information may be used automatically, in some embodiments, to purchase the item in step 806. If the offer is not accepted, the user may enter into negotiations, in step 807 in accordance with various embodiments disclosed herein. Exemplary rules that may be implemented for facilitating negotiation in accordance with various embodiments of negotiable pricing systems disclosed herein are provided in the attached appendix, APPENDIX A. Once a user has entered their payment information, even if their original offer is not accepted, the member may not be required to re-enter payment information. The previously entered information may be used to automatically complete the transaction once the user submits a new offer that is accepted.

Various embodiments disclosed herein provide an abundance of information and statistics related to consumer shopping preferences and retailer sale transactions. Accordingly, various other inventive embodiments are directed to creating and capturing information on consumer shopping preferences or consumer willingness-to-pay data. Such embodiments may be implemented to generate pricing models and for targeted advertisements based on information including, but not limited to member offers and counter offers, identification information including bibliographic and demographic information, acceptance of counter offers, selected products, number of purchase and offer attempts, use of rewards and or incentives, timing or duration of negotiation, and any other data that may identified and accessed from the shopping and negotiation processes that occur through the use of the negotiable pricing system embodiments described herein.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the inventive aspects have been particularly shown and described with reference to specific embodiments, it should be understood by those skilled in the art that various changes in form and detail may be made therein without departing from the spirit and scope of the inventive aspects described in this disclosure.

APPENDIX A
Exemplary Negotiable Pricing System Rules

| BusRule # | Rule |
|---|---|
| BusRule 1 | Algorithm to determine acceptable/rejected offer. |
| | Calculated Hidden Threshold = Baseline Cost + (Baseline Cost * 5%~10%) + (My Offer * |
| | Nyopoly Money %) |
| BusRule 2 | Algorithm to determine Counter offer price. |
| | Counter Offer Price = RoundUp(List Price − (List Price − Calculate Hidden Threshold) * |
| | ((Offer/Calculate Hidden Threshold)/N)) + .99 |
| | If offer is 10% or less of List Price, then the Counter Offer Price will automatically |
| | default 95% of list. |
| BusRule 3 | Algorithm to determine Nyopoly money earned on product page [symbol] counter page. |
| | Nyopoly Money = (nyopoly money used) * (nyopoly money % earn) |
| BusRule 4 | Algorithm to determine Total Savings on product page [symbol] counter page. |
| | Total Savings = (retail price − offer) + ((nyopoly money used) * (nyopoly money % earn)) |
| BusRule 5 | Algorithm to determine Nyopoly money earned on credit card page. |
| | Nyopoly Money for CC page = (offer − nyopoly money used) * (nyopoly money % earn) |
| BusRule 6 | Algorithm to determine Total Savings earned on credit card page. |
| | Total Savings for CC page = (retail price − offer) + ((offer − nyopoly money used) * |
| | (nyopoly money % earn)) + (nyopoly money used) |
| BusRule 7 | Member will be “locked” from making offers on a given product for 48 hours if they |
| | reach the “Buy” ONLY state. |
| BusRule 8 | A “locked” out Members will be offered a 10% discount on a product for the 48 hour |
| | period. |

1. A method for facilitating a purchase of a product by a user, the method comprising:
causing, by a server, on a display device, a display of a product available for purchase and a price for the product available for purchase, the server providing a user interface to the display device for the user to submit a purchase offer for purchase of the product at or below the price, the server also providing an incentive to the user, the incentive conditioned on the server accepting the purchase offer for the product;
receiving, by the server, via the user interface, the purchase offer for purchase of the product at or below the price from the user;
determining, by the server, to accept the purchase offer if the purchase offer has a value greater than a threshold value, the threshold value comprising a baseline cost of the product and a quantification of the incentive; and
providing, by the server, responsive to the determination to accept the purchase offer, the incentive to the user.

2. The method of claim 1 further comprising:
determining, by the server, to reject the purchase offer, if the purchase offer has a value less than or equal to the threshold value.

3. The method of claim 2, further comprising:
providing, by the server, responsive to the determination to reject the purchase offer, a counter offer to the user.

4. The method of claim 3, wherein the counter-offer includes a counter-offer incentive, the counter-offer incentive conditioned on the user accepting the counter-offer.

5. The method of claim 4, wherein the counter-offer incentive is determined based on a difference between the purchase offer and the threshold value.

6. The method of claim 4, wherein at least one of the counter offer and the counter offer incentive is determined based on an offer state, wherein the offer state quantifies the number of offers the user has made for the product.

7. The method of claim 4, wherein the value of the counter-offer incentive is less than the incentive.

8. The method of claim 1, wherein the threshold value further comprises a minimum profit value.

9. The method of claim 1, wherein the incentive includes a currency.

10. The method of claim 1, wherein the incentive includes a credit towards a subsequent purchase.

11. The method of claim 1, wherein the incentive includes a second product.

12. The method of claim 11, wherein the second product is chosen based on a behavior of the user.

13. The method of claim 1, wherein the purchase offer includes a credit from a prior purchase.

14. The method of claim 1, wherein the product available for purchase is from a single seller.

15. The method of claim 1, wherein the price of the product is a manufacturer suggested retail price.

16. The method of claim 1, further comprising causing, by the server, on the display device, a display of a written description of the product.

17. A system for facilitating a purchase of a product by a user from a seller, the system comprising:
a product purchase engine, the product purchase engine configured to:
A) cause a display of product data corresponding to a product available for purchase
B) cause a display of a price for the product available for purchase,
C) provide a user interface for the user to submit a purchase offer for purchase of the product at or below the price,
D) provide an incentive to the user, the incentive conditioned on the product purchase engine accepting the purchase offer for the product;
E) receive, via the user interface, the purchase offer for purchase of the product at or below the price from the user;
F) determine, to accept the purchase offer if the purchase offer has a value greater than a threshold value, the threshold value comprising a baseline cost of the product and a quantification of the incentive; and
G) provide, responsive to the determination to accept the purchase offer, the incentive to the user.

18. The system according to claim 17, wherein the product purchase engine is further configured to:
H) reject the purchase offer, if the purchase offer has a value less than or equal to the threshold value and
I) provide, responsive to the rejection of the purchase offer, a counter offer to the user.

19. The system according to claim 17, wherein the product data includes an image representative of the product available for purchase.

20. A system for facilitating a purchase of a product by a user, the system comprising:
a server configured to cause, on a display device, a display of a product available for purchase and a price for the product available for purchase, the server configured to provide a user interface to the display device for the user to submit a purchase offer for purchase of the product at or below the price, the server also configured to provide an incentive to the user, the incentive conditioned on the server accepting the purchase offer for the product,
wherein the server is configured to receive, via the user interface, the purchase offer for purchase of the product at or below the price from the user,
wherein the server is configured to determine to accept the purchase offer if the purchase offer has a value greater than a threshold value, the threshold value comprising a baseline cost of the product and a quantification of the incentive, and
wherein the server is configured to provide, responsive to the determination to accept the purchase offer, the incentive to the user.
